(19) United States
(12) Patent Application Publication
(10) Pub. No.: US 2019/0226574 A1
(43) Pub. Date: Jul. 25, 2019

(54) VENT FOR PRESSURE EQUALIZATION

(71) Applicant: W. L. Gore & Associates, Inc., Newark, DE (US)

(72) Inventors: Daniel E. Basham, Pylesville, MD (US); Nicholas Lombardi, Newark, DE (US)

(21) Appl. No.: 16/246,105

(22) Filed: Jan. 11, 2019

Related U.S. Application Data
(63) Continuation of application No. 14/341,912, filed on Jul. 28, 2014, now abandoned.
(60) Provisional application No. 61/983,067, filed on Apr. 23, 2014.

(51) Int. Cl. F16H 57/04; F15B 13/043

(52) U.S. Cl. CPC F16H 57/04; F16H 61/4165; F15B 13/0438

(57) ABSTRACT

A vent system for pressure equalization of an enclosure, such as a gearbox housing or axle of an automobile. The vent system includes a vent module including a housing defining a passageway, a membrane maintained in the passageway, and a sorbent maintained in the passageway; and a flow control module associated with the vent module and including a valve having an inner channel.

### BACKGROUND

Generally, this disclosure relates to embodiments of systems, methods, and devices for venting an enclosure. Some embodiments relate more specifically to venting an enclosure containing synthetic or non-synthetic oil-based products, such as an enclosure containing machinery and a lubricant, for example.

Gas-permeable, liquid-impermeable vents find use in many applications in the automotive industry, such as electrical component housings, gear housings, vehicle bodies, and brake housings, for example, where pressure equalization between a housing interior and the surrounding environment is desirable. Machinery enclosures, such as gearbox housings and axles, are often subject to thermal cycling. As the machinery is operated, temperatures of the lubricant and internal air begin to rise, causing air pressure to rise in the enclosure. When the machinery is stopped, temperature and pressure fall within the enclosure. Vents are often employed with the dual purposes of facilitating pressure equalization while sealing the interior of the housing from liquid, dirt, dust particles, or other unwanted contaminants. Failure to exclude water or other contaminants from various automotive housings can result in damage to the interior of the housing, damage to the components in the housing, or other undesirable results, such as reduced machinery performance, for example.

Some machinery vents employ expanded polytetrafluoroethylene (ePTFE) membranes, where the vent includes a body having a passageway and a gas-permeable, water-impermeable ePTFE membrane covering the passageway, and a fibrous sorbent disposed within the passageway between the machinery space and the ePTFE membrane for sorption of lubricant aerosol.

### BRIEF DESCRIPTION OF THE DRAWINGS

FIG. 1 is a perspective, or isometric view of a vent system in a disassembled state, according to some embodiments.

FIG. 2 is an enlarged, sectional view of a portion of the vent system of FIG. 1 in the disassembled state with the section taken along the longitudinal axis of the system, according to some embodiments.

FIG. 3 is an isometric view of a valve of the vent system of FIG. 1, according to some embodiments.

FIG. 4 is a sectional view of the valve of FIG. 3 with the section taken longitudinally along the valve, according to some embodiments.

FIG. 5 is an end view of the valve of FIG. 3, according to some embodiments.

FIG. 6 is a sectional view of a valve configuration similar to that shown in FIG. 3 with the section taken longitudinally along the valve, according to some embodiments.

FIG. 7 is a schematic view showing valve operation, according to some embodiments.

FIG. 8 is a perspective view showing another valve and another vent module body employed in the system of FIG. 1, according to some embodiments.

FIG. 9 shows another valve, which is a duckbill valve.

FIG. 10 is a perspective view of an insert for a buckbill valve according to an exemplary embodiment of an aspect of this disclosure.

FIG. 11(a) is a perspective view of the insert of FIG. 10 disposed in a duckbill valve according to an exemplary embodiment of an aspect of this disclosure.

FIG. 11(b) is a cross-sectional view of the insert of FIG. 10 disposed in a duckbill valve according to an exemplary embodiment of an aspect of this disclosure.

### DETAILED DESCRIPTION

Various embodiments described herein provide systems, methods, and devices for venting a liquid containing enclosure using a flow control module to enhance service life and overall venting system performance, for example. Some embodiments relate to a cost effective, easy to integrate, and durable vent system for venting an enclosure containing synthetic or non-synthetic oil-based liquids, such as lubricants, fuel, transmission oil, and hydraulic fluids, although a variety of liquids are contemplated. Such enclosures can include vehicle housings such as gear housings, axle housings, fuel tank housings, electrical component housings, and brake housings, for example.

Some embodiments relate to a venting system for an enclosure that includes a flow control module to help avoid or reduce instances of liquid from the enclosure migrating through the venting system and coming into unwanted contact with sorbent of the venting system where such contact can otherwise reduce overall sorption capacity of the sorbent, and thus reduce service life and overall performance of the venting system. In some embodiments, the control module includes a valve configured to help reduce or prevent contact between liquid inside the enclosure and the fibrous sorbent while allowing effective pressure equalization between the interior of the enclosure and the environment. Although some features and advantages of systems, methods, and devices are described by way of example, various additional and alternative features and advantages are contemplated.

U.S. Publication No. 2007/0240537, filed Apr. 17, 2006 and entitled “Axle Vent” discloses various components and features associated with vent modules for a machinery space, the entire contents of which are incorporated herein by reference for all purposes.

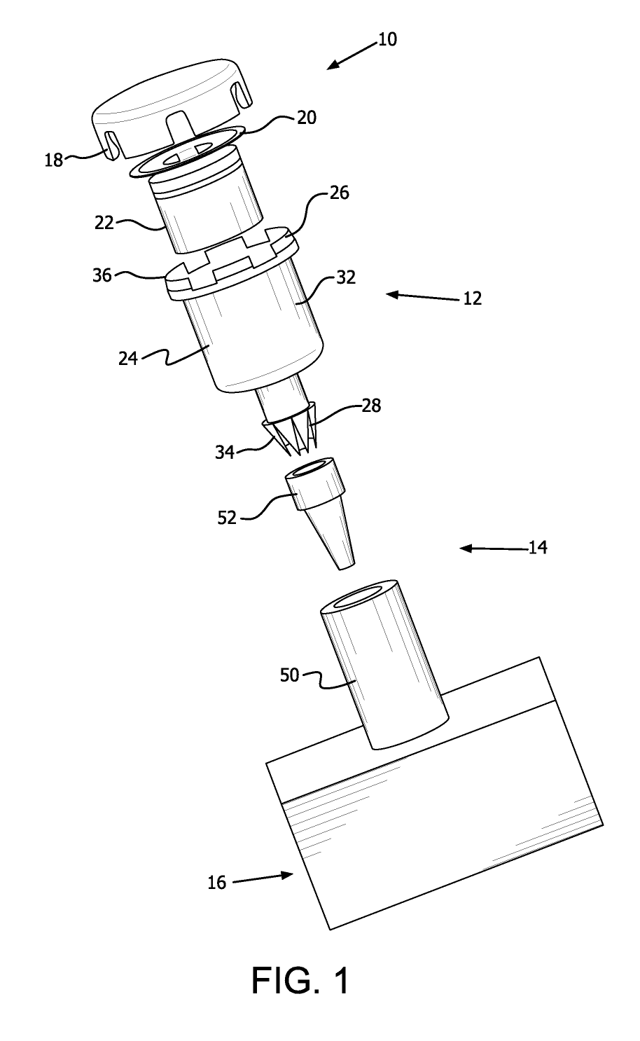

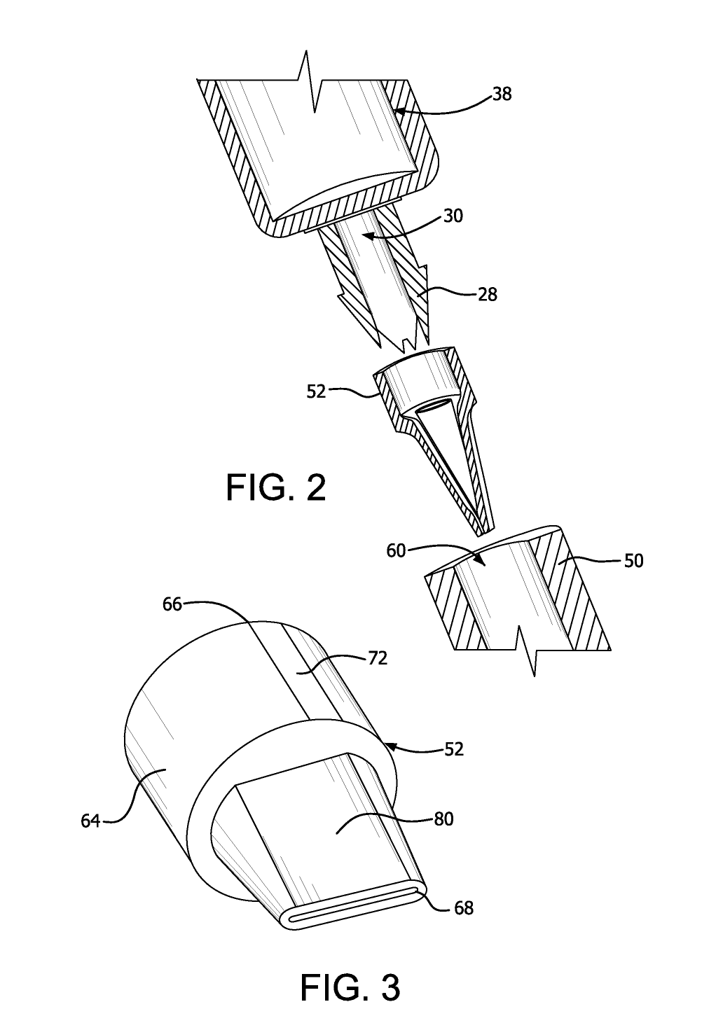

FIG. 1 is a perspective, or isometric view of a vent system 10 in a disassembled state, according to some embodiments. FIG. 2 is an enlarged, sectional view of a portion of the vent system 10 in the disassembled state with the section taken along the longitudinal axis of the system 10, according to some embodiments. As shown, the vent system 10 includes a vent module 12 and a flow control module 14 secured to an enclosure 16, which is indicated generally as a box in FIG. 1.

The vent module 12 includes a cap 18, also described as a cover, a membrane 20, also described as a filter, a sorbent 22, also described as a pre-filter, and a body 24, also described as a housing. In some embodiments, the vent module 12 is an automotive vent for powertrain components sold by W.L. Gore & Associates of Newark, Del. under the trade name, “SERIES: AVS 41.”

In some embodiments, the cap 18 of the vent module 12 is configured to form a complementary fit with the body 24 (e.g., a snap fit) or to otherwise be secured to the body 24 and allows air or other gas to pass into and out of the body 24 during pressure equalization.

In some embodiments, the body 24 of the vent module 12 has a first end 26 and a second end 28 and defines a first passageway 30 (FIG. 2), also described as a flow path, which extends through the body 24 from the first end 26 to the second end 28. As shown, the body 24 includes a receptacle portion 32 toward the first end 26 and an insert portion 34 toward the second end 28. The receptacle portion 32 optionally defines a seat 36 for receiving the membrane 20 and a barrel 38 (FIG. 2) for receiving the sorbent 22. The insert portion 34 of the body 24 is optionally configured to be inserted into and mate with a connector, such as relatively flexible or inflexible tubing, for example. As shown, the receptacle portion 32 has a larger diameter than the insert portion 34, where the seat 36 generally defines a larger diameter than the barrel 38 of the receptacle portion 32.

In some embodiments, the membrane 20 is configured to be received in the seat 36 of the body 24 and to cover the first passageway 30. The membrane 20 is hydrophobic, gas-permeable, and liquid-impermeable, according to some embodiments. In some embodiments, the membrane 20 is oleophobic. The membrane 20 is optionally formed of ePTFE, such as an ePTFE membrane sold by W.L. Gore & Associates of Newark, Del. under the trade name “AM6XX.”

In some embodiments, the sorbent 22 is substantially cylindrical in shape or is otherwise shaped to be received in the barrel 38 of the body 24. The sorbent 22 is optionally formed of a fibrous material, including natural fiber material, for example. The sorbent 22 is disposed within the first passageway 30 such that air flowing from the enclosure 16 encounters the sorbent 22 before the membrane 20, according to some embodiments.

In some embodiments, the flow control module 14 includes a connector 50 and a valve 52, also described as a flow control element. As shown, the flow control module 14 is a separate component attached to the vent module 12. In other embodiments, the flow control module 14 is formed as a part of the vent module 12. For example, components of the flow control module 14 are optionally formed as a part of the body 24 such as when the connector 50 is integral with or part of the body 24 and/or when the valve 52 is disposed inside a portion of the body 24.

In some embodiments, the connector 50 of the flow control module 14 is a hollow, cylindrical tube defining a second passageway 60 (FIG. 2), also described as a second flow pathway. In some embodiments, the vent module body 24, and thus the first passageway 30 is connected to the connector 50 by inserting the insert portion 34 into the connector 50 and/or the valve 52. In turn, the connector 50 is connected to the enclosure 16 to create a flow path through the first and second passageways 30, 60 to the enclosure 16.

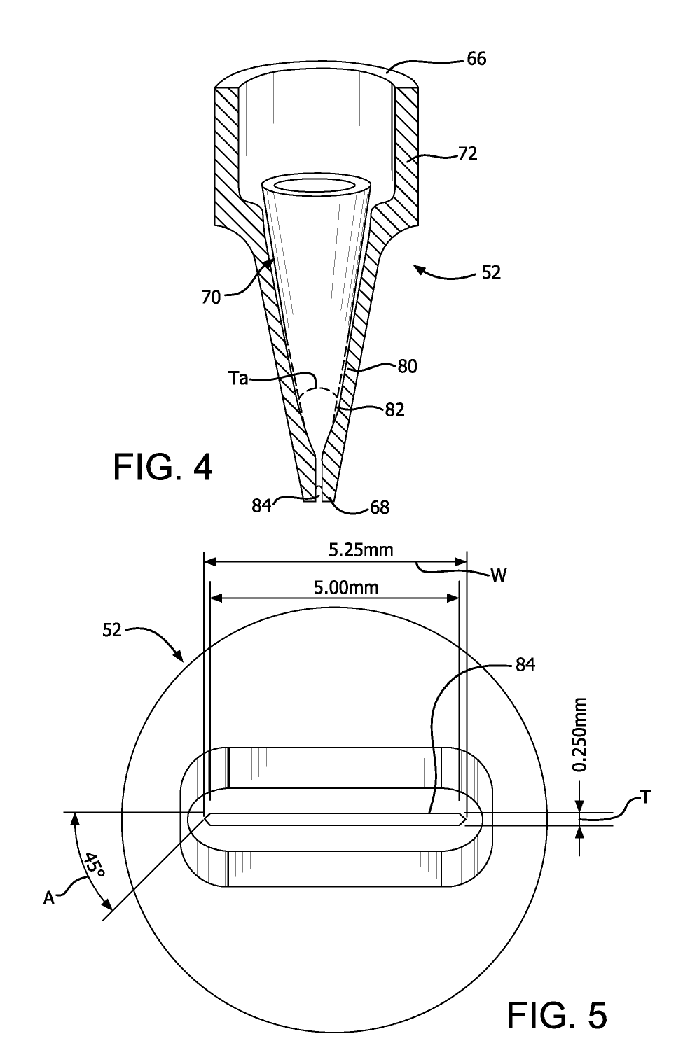

Though shown in a disassembled state in FIGS. 1 and 2, the valve 52 is disposed at least partially within the second passageway 60 when the flow control module 14 is in an assembled state. FIG. 3 is an isometric view of the valve 52, FIG. 4 is a sectional view of the valve 52 with the section taken longitudinally along the valve 52, and FIG. 5 is an end view of the valve 52, according to some embodiments.

As shown in FIGS. 3 to 5, the valve 52 includes a body 64 defining a first end 66, a second end 68, and an inner channel 70 extending between the first and second ends 66, 68. In some embodiments, the body 64 includes a first portion 72 toward the first end 66 and a second portion 80 toward the second end 68. The first portion 72 is optionally adapted to receive the insert portion 34 of the vent module body 24. As show, the second portion 80 thins, or tapers to a reduced overall thickness at the second end 68 and the first portion 72 is substantially non-tapered or has a relatively constant thickness.

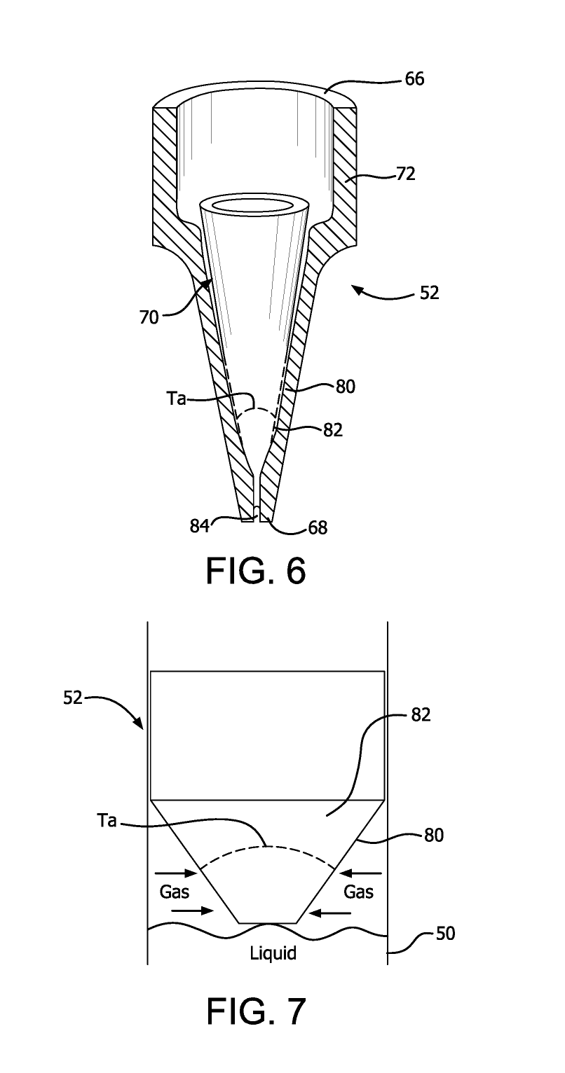

As shown in FIG. 4, the inner channel 70 at the tapered portion 80 defines a tapered section 82 that narrows, or tapers in width to a slot 84, that is open at second end 68. In some embodiments, the tapered section 82 defines a taper angle Ta⋅ from about 5 degrees to about 80 degrees. In some embodiments, the taper angle Ta is about 10 degrees, although a variety of angles are contemplated. As shown, the slot 84 is relatively thin (e.g., compared to the origin of the inner channel 70 at the first end 66 of the first section 82 of the inner channel 70). As shown in FIG. 4, the taper of the tapered section 82 stops before the second end of the body 64. FIG. 6 shows the valve 52, according to some other embodiments where the tapered section 82 terminates at the slot 84 at the second end 68 of the body 64.

The body 64 is optionally formed of an elastomeric material to help allow the body 64 to selectively prevent fluid (e.g., lubricant) from flowing up through the slot 84 and back through the inner channel 70 while permitting gas (e.g., air) to pass in both directions, from the first end 66 to the second end 68 and vice versa, during pressure equalization. In other words, the valve 52 is adapted to allow air or other gases to flow in both directions within the first and second passageways 30, 60, for example to facilitate pressure equalization between the environment and the enclosure 16, such as a machinery space, while acting as a barrier to liquid, such as lubricant. For example, the narrowed inner channel 70 at the slot 84 remain open to permit air flow in either direction through the valve 52 (a cracking pressure of zero), but the body 64 is sufficiently flexible and tapered and the inner channel 70 is sufficiently narrow at the slot 84, such that that body 64 flexes to close the inner channel 70 when the valve 52 is under pneumatic pressure to impede fluid flow through the valve 52.

FIG. 7 is a schematic showing valve operation according to some embodiments. As shown in the schematic of FIG. 7, when a liquid such as liquid lubricant approaches the valve 52, pneumatic pressure due to trapped air outside of the tapered portion 80 of the valve body 64 applies pressure to the tapered portion 80 of the body 64, pinching the tapered section 82 of the inner channel 70 closed, thereby impeding liquid flow.

In some embodiments, the valve 52 is formed of cross-linked elastomers or thermoplastic elastomers having adequate chemical, thermal, and/or mechanical resistance to the fluid in the enclosure 16. For example, in some embodiments the valve 52 is formed from a blend of Nitrile rubbers such as NBR and HNBR, fluoropolymer elastomers such as Viton or Fluorosilicone, or others. It has been found that soft elastomeric materials (e.g., 25 Shore A or less) are particularly suitable for lubricant applications, although other hardness materials are employed depending upon implementation desired. The valve 52 is optionally formed using molding methods such as liquid injection molding (LIM) or compression molding.

As shown in FIG. 5, the slot 84 defines a slot geometry including a width W, a slot thickness T, and an end chamfer angle A In some embodiments, the slot thickness T is about 1 mm or less, about 0.250 mm or less, or about 0.125 mm or less, and the slot width W is at least 2 mm, although a variety of dimensions are contemplated. In some embodiments, the end chamfer angle is less than 90 degrees or is about 45 degrees, or is non-orthogonal and 45 degrees or greater, for example, although a variety of angles are contemplated.

According to various methods of forming the valve 52⋅, slot geometry is selected based upon hardness of an elastomer used to construct the valve 52. For example, it has been found that a valve similar to the design of valve 52 and formed of an elastomeric material having a durometer of about 25 Shore A effectively closes with slot thickness T of about 1 mm, while those made with elastomers of a higher durometer material of about 80 Shore A required a slot thickness T of less than about 0.125 mm. Although some examples of effective slot thicknesses and material durometers have been provided, it should be understood that additional factors contribute to effective valve closing action, including taper angle, slot geometry, fluid type, fluid temperature, fluid pressure and the rate at which the fluid pressure is applied to the valve 52, for example.

In some embodiments, the enclosure 16 (FIG. 1), also described as a machinery space, contains a liquid (not shown), such as a synthetic or non-synthetic petrochemical lubricant, and components (not shown), such as gears or other machinery, that applies a shearing force to the liquid during operation of the machinery. In some embodiments, the enclosure 16 is a powertrain gearbox housing. In other embodiments, the enclosure 16 houses fuel or electrical components, for example, in need of two way air venting with a liquid barrier.

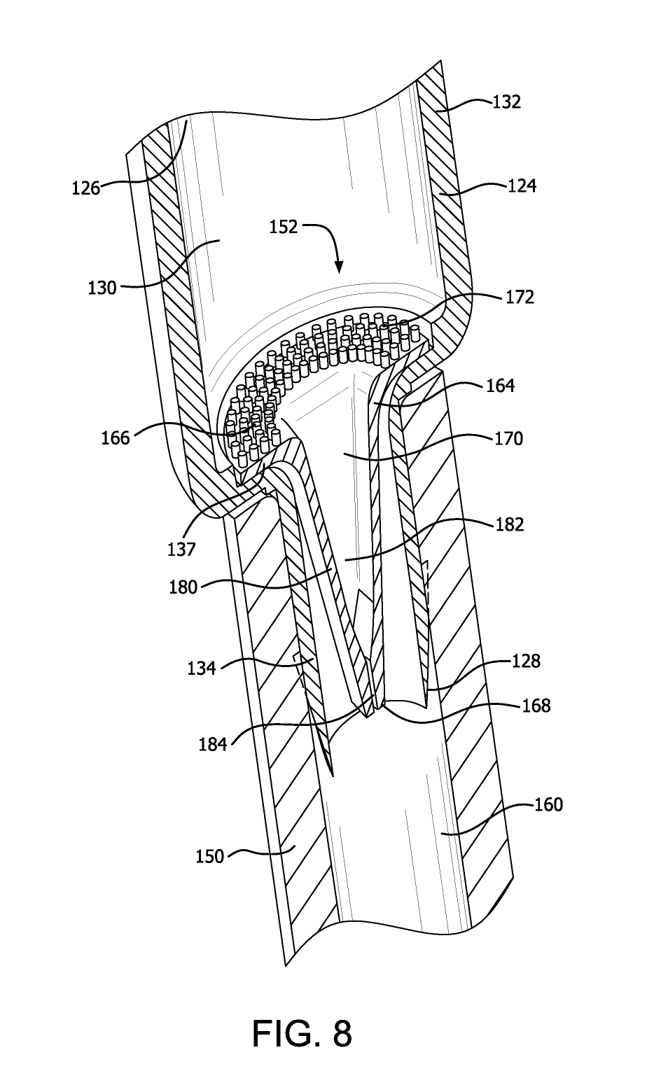

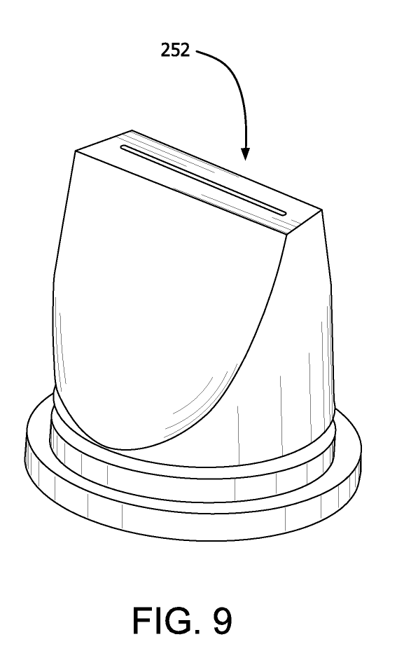

FIG. 8 is a perspective view showing another valve 152 and another vent module body 124 employed in the system 10, according to some embodiments. As shown, the valve 152 is positioned inside of the body 124 and the body 124 is positioned in the connector 150. The valve 152 is optionally formed of similar materials using similar techniques with similar slot geometries to those previously described, according to some embodiments.

As shown in FIG. 8, the body 124 is optionally substantially similar to the body 24, where the body 124 has a first end 126 and a second end 128 and defines a first passageway 130, also described as a flow path, which extends through the body 124 from the first end 126 to the second end 128. Similarly to the body 24, the body 124 includes a receptacle portion 132 toward the first end 126 and an insert portion 134 toward the second end 128.

As shown, the receptacle portion 132 optionally defines a valve seat 137 for receiving the valve 152. In some embodiments, the valve seat 137 is an annular recess at the transition from the receptacle portion 132 to the insert portion 134. In some embodiments, a flexible or inflexible tubular element, such as the connector 150 is utilized to connect the vent module body 124, and thus the first passageway 130 to the enclosure 16 (e.g., by inserting the insert portion 132 into the tubular element and connecting the tubular element to the enclosure 16).

As shown in FIG. 8, the valve 152 includes a body 164 defining a first end 166, a second end 168, and an inner channel 170 extending between the first and second ends 166, 168. In some embodiments, the body 164 includes a first portion 172 toward the first end 166 that defines an widened flange and a second portion 180 toward the second end 168, where the second portion 180 thins, or tapers to a reduced overall thickness at the second end 168 and the first portion has a greater cross-section or thickness. The first portion, or widened flange, is optionally received in the seat 137 and secured there (e.g., using an adhesive or other fastening means).

As shown, the inner channel 170 at the tapered portion 180 defines a first section 182, also described as a tapered section, that narrows, or tapers in width to a slot 184 that is open at second end 168. As shown, the slot 184 is relatively thin (e.g., compared to an origin of the inner channel 170 at the first end 166).

In some embodiments, the body 164 is formed of an elastomeric material selected to help selectively prevent fluid (e.g., lubricant) from flowing up through the slot 184 and back through the inner channel 170 while permitting gas (e.g., air) to pass in both directions, from the first end 166 to the second end 168 and vice versa, during pressure equalization. In other words, similarly to various embodiments of the valve 52, the valve 152 is adapted to allow air or other gases to flow in both directions through the inner channel 170, for example to facilitate pressure equalization between the environment and the machinery space, while acting as a barrier to liquid, such as a liquid lubricant, from passing through the body 164 from the second end 168 to the first end 166.

FIG. 9 shows another valve 252, which is a duckbill valve. Although not shown, the valve 252 is optionally modified from the depicted duckbill valve to form a valve according to various embodiments by molding a slot (not shown) into the tapered end of the valve 252 to allow airflow passage in both directions while helping minimize pressure drop across the valve (e.g., to achieve zero cracking pressure). It should be understood that a traditional duck valve configuration (e.g., as shown in FIG. 9) narrows to a slit end that is normally in a closed state. The valve is a one-way valve that allows airflow in one direction only and only once a predetermined amount of pressure is applied from inside the valve, commonly referred to as “cracking pressure.” According to some embodiments, the valve 252 is modified, for example similarly to valves 52, 152 to include a slot that accomplishes a normally open duck bill valve configuration having a cracking pressure of zero. The slot may be constructed either during molding or in a secondary operation wherein the slot may be stamped out of the typical duck bill valve.

In another aspect, in order to prevent leaks around the corners of a buckbill valve, this disclosure includes a rigid insert which closely resembles the interior surface of the molded duck-bill; however much of the geometry is slightly undersized to allow airflow between the rigid element and the elastomer valve body. When corner geometry of the rigid insert matches the inside of the duckbill, the interior corners of the elastomer can be pulled in tension. This tension enables the elastomer to permit airflow between the flat rectangular surfaces of the valve during ambient conditions; however the flat surfaces will contact the matching surfaces of the rigid insert during positive pressure conditions. In the pressurized, “closed” condition, the insert provides large sealing surfaces for the elastomer, as well as support for the “pinched” corners of the elastomer duckbill. This supporting element is a new way of preventing leaks through the corners of the duckbill described above.

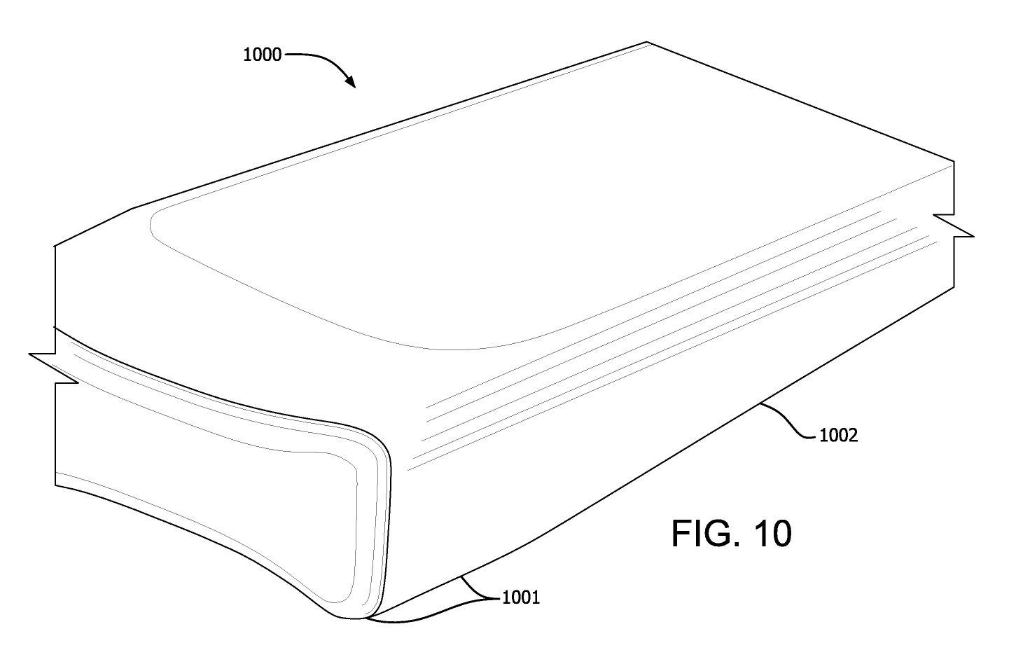

In this regard, FIG. 10 shows an insert 1000 having edges 1001 and a taper 1002. Edges 1001 and taper 1002 are sized such that they fit snugly into an inner channel of a duckbill valve while leaving space for airflow but promoting sealing of the valve against upstream fluid flow.

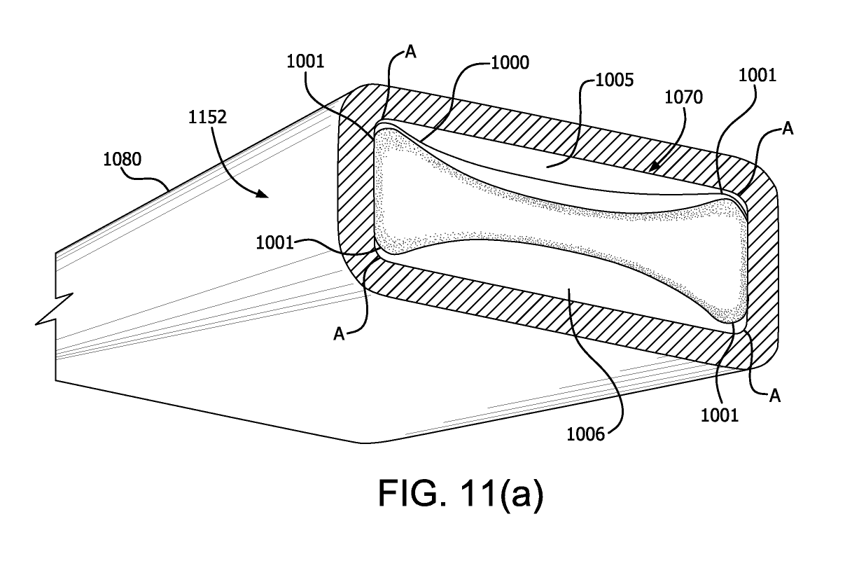

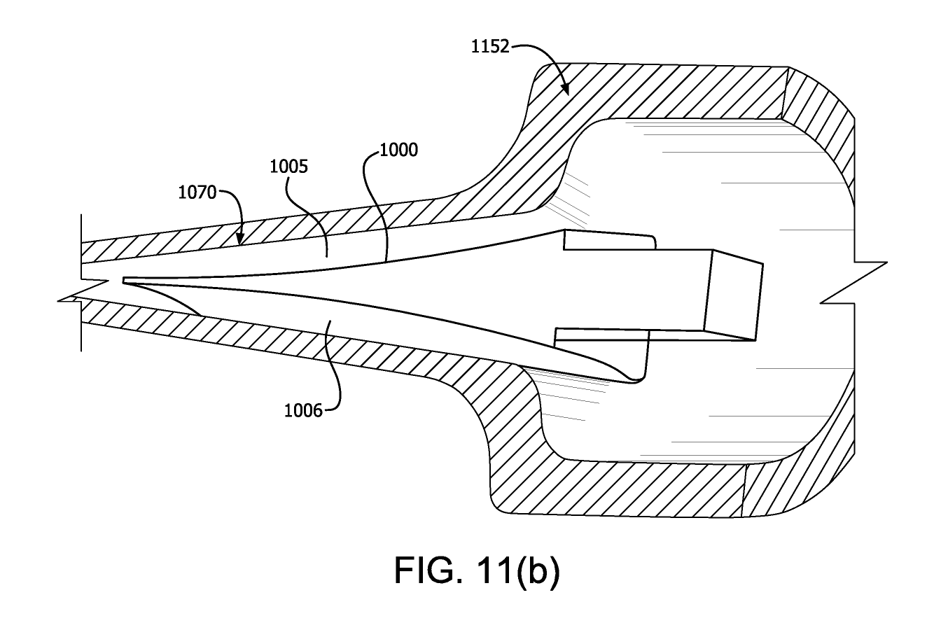

FIG. 11(a) shows insert 1000 seated within inner channel 1070 of duckbill valve 1152. Edges 1001 engage the corners (chamfer angles A) of inner channel 1070. Spaces 1005 and 1006 allow air flow around insert 1000 and through duckbill valve 1152. When tapered portion 1080 duckbill valve 1152 is sealed or pinched, by application of pressure from the external sides thereof, spaces 1005 and 1006 are closed to form a seal prevent fluid flow into inner channel 1070 of duckbill valve 1152. The seal is particularly tight at the chamfer angles A because of the secure engagement of edges 1001 of insert 1000 therewith. Using such an insert 1000, leakage of fluid into duckbill valve 1152 at the chamfer angle A is prevented or greatly reduced.

FIG. 11(b) shows a cross-sectional view of insert 1000 seated within inner channel 1070 of duckbill valve 1152. This view further illustrates spaces 1005 and 1006 described in connection with FIG. 11(a).

The particular size and shape of the insert can vary, depending on the specific design of both the duckbill (or other type) of valve, and the sealing characteristics thereof. In particular, means for anchoring the insert within the valve may vary from a simple friction fit, to integration with a cap or other supporting member extending out of or beyond the wide end of the valve and mated with the insert portion of a receptacle or connector or outer tube themselves.

The material of construction of the insert can also vary, provided that such material is capable of sealing against the valve under pressure in use. Preferred materials for the insert include polyamides such as nylon, polyesters, polyolefins such as polypropylene or polyethylene, and polyetherimides.

### EXAMPLES

A valve configured similarly to the valve 52 was constructed using stereo lithography by injecting a viscous elastomer into a molding tool with subsequent vulcanization resulting in a cross-linked elastomeric sample. The valve was formed of an RTV elastomer, silicone, having a durometer of about 60 Shore A. The slot geometry included a slot thickness T of about 0.25 mm, a slot width W of about 5 mm discounting the end chamfer or a maximum slot width W of about 5.25 mm including the end chamfers. During testing, air flow of the valve of this example was measured to permit desirable air flow, indicating that the valve has adequate airflow to function as an effective vent for pressure equalization. No liquid lubricant passage was observed during the liquid resistance test indicative of the efficacy of the flow control element as a barrier to liquid flow.

### Comparative Example

A traditional duck bill valve without a slot according (e.g., with a slit as shown in the valve 252 of FIG. 9) was constructed by using stereo lithography. The air flow of this sample was measured to be zero, indicating that the unmodified design was ineffective for pressure venting.

Test Methods

Effective operation of the valve was tested using the following test methods.

Air Flow Test

The air flow through the valve was measured at a pressure differential of 0.19 psi across the element. An air flow measurement of at least 100 ml/min was selected as indicative the valve would have enough air flow to function as an effective vent for pressure equalization.

Liquid Resistance Test

The valve was pressurized with a liquid lubricant (tapered end facing direct lubricant flow) at a pressure ranging from 0.036 psi up to 5 psi. A lack of fluid passing through a valve is indicative of the efficacy of the valve as a liquid barrier.

While particular invention embodiments have been illustrated and described herein, the scope of invention should not be limited to such illustrations and descriptions. For example, although some valves are described taking the form of a modified duckbill valve, valves having any of a variety of forms and shapes are contemplated according to various embodiments. It should be apparent that changes and modifications may be incorporated and embodied as part of the invention within the scope of the following claims.

1. A vent system for pressure equalization of an enclosure comprising: a flow control module associated with the vent module and including a valve having an inner channel through which air is able to flow in a first direction and a second, opposite direction through the valve, where the flow control module acts as a barrier to liquid flow through the valve from the enclosure toward the sorbent.

2. The vent system of claim 1, wherein the valve body defines a tapered portion and an inner channel through the tapered portion that terminates at a slot, where the valve is adapted for the inner channel to remain open to air flow in the first and second directions through the inner channel of the valve and to selectively close to act as the barrier to liquid flow through the valve toward the sorbent.

3. The vent system of claim 1, wherein the valve is formed of an elastomeric material having a shore hardness of greater than about 25 Shore A or less.

4. The vent system of claim 1, wherein the valve is adapted to act as a barrier to a petrochemical lubricant.

5. The vent system of claim 1, wherein the membrane is a gas permeable, water impermeable membrane.

6. The vent system of claim 1, wherein the membrane is formed of ePTFE material.

7. The vent system of claim 1, wherein the slot defines a slot width of about 5 mm or less, a slot thickness of about 0.25 mm or less, and a non-orthogonal end chamfer angle of about 45 degrees or more.

8. The vent system of claim 1, wherein the valve has an inner channel that defines a tapered section having a taper angle from about 5 degrees to about 80 degrees.

9. The vent system of claim 1, wherein the valve is characterized by a cracking pressure of zero.

10. The vent system of claim 1, wherein the vent module forms a part of the flow control module.

11. The vent system of claim 1, wherein flow control module is disposed within the housing of the vent module.

12. The vent system of claim 1, wherein the flow control module includes a connector secured to the housing of the vent module, the valve of the flow control module being positioned within the connector.

13. The vent system of claim 2 further comprising an insert disposed within said inner channel.

14. The vent system of claim 13 wherein said inner channel comprises comers and said insert engages said inner channel at said corners.

15. The vent system of claim 14 further wherein said insert is of such a shape to define at least one space between said insert and said inner channel permitting air flow through said inner channel, and wherein said insert is adapted to engage said inner channel and seal said space upon pinching of said tapered portion of said valve body.

16. A vented system for pressure equalization of an enclosure comprising: an enclosure containing a liquid; a vent module including a housing defining a passageway in pneumatic communication with the enclosure, a membrane maintained in the passageway, and a sorbent maintained in the passageway; and a flow control module associated with the vent module and including a valve having an inner channel through which air is able to flow in a first direction from the enclosure through the vent module and a second, opposite direction while acting as a barrier to liquid flow through the valve from the enclosure.

17. The vented system of claim 16, wherein the enclosure is a machine space and the liquid is a lubricant.

18. A valve for pressure equalization of an enclosure, the valve comprising a body having a first end, a second end and an inner channel extending from the first end to the second end, the inner channel defining a tapered section that decreases in width in a direction from the first end toward the second end to a slot formed at the second end, the slot being adapted to allow air to flow in a first direction and a second, opposite direction through the inner channel and the tapered section of the inner channel being adapted to flex closed under pressure.
